(19) United States
(12) Patent Application Publication
(10) Pub. No.: US 2013/0126060 A1
(43) Pub. Date: May 23, 2013

(54) STIFFNESS ENHANCED TREAD

(71) Applicants: Kenneth Lee Oblizajek, Troy, MI (US); Arthur Allen Goldstein, Mayfield Village, OH (US); Jonathan Michael Darab, West Bloomfield, MI (US); Paul Harry Sandstrom, Cuyahoga Falls, OH (US); William Ronald Rodgers, Bloomfield Township, MI (US); Jennifer Lyn Ryba, Wadsworth, OH (US); Rachel Tamar Graves, Stow, OH (US); Chad Edward Melvin, Akron, OH (US)

(72) Inventors: Kenneth Lee Oblizajek, Troy, MI (US); Arthur Allen Goldstein, Mayfield Village, OH (US); Jonathan Michael Darab, West Bloomfield, MI (US); Paul Harry Sandstrom, Cuyahoga Falls, OH (US); William Ronald Rodgers, Bloomfield Township, MI (US); Jennifer Lyn Ryba, Wadsworth, OH (US); Rachel Tamar Graves, Stow, OH (US); Chad Edward Melvin, Akron, OH (US)

(21) Appl. No.: 13/302,485

(22) Filed: Nov. 22, 2011

(51) Int. Cl. B60C 11/00

(52) U.S. Cl. 152/209.1

(57) ABSTRACT

A pneumatic tire includes a tread base comprised of a first material, a tread cap comprised of a second material, and a plurality of plugs comprised of a third material. The tread cap is disposed radially outward of the tread base and in operational contact with a ground surface. The plurality of plugs are disposed at least partially within the tread cap. The plurality of plugs yield a tread stiffness in one direction greater than stiffness in at least one other direction.

### FIELD OF INVENTION

This invention generally relates to methods and apparatuses concerning pneumatic tires and more specifically to methods and apparatuses concerning a pneumatic tire having a tread with plugs of a relatively high stiffness material extending through a relatively lower stiffness tread material.

### DESCRIPTION OF THE RELATED ART

It is known to those of skill in the art that the overall performance of a pneumatic tire's tread pattern (including performance criteria such as wet handling, dry handling and stopping) may be influenced by the stiffness characteristics of the tread elements. Certain tire response properties improve while others degrade with conventional practices for increasing stiffness. Examples of present-day methods for increasing the stiffness of a tread element include using relatively stiffer tread base and cap materials. Although these methods are advantageous for certain tire responses, mechanical actions and performance characteristics, they typically have the disadvantage, however, of compromising other tread actions and performance criteria. Certain advantages, furthermore, derive from exploiting stiffness properties in desired directions, such as significantly stiffening the tread in one direction, while achieving relatively low stiffness in directions other than the desired stiffening direction. Previously, these directional stiffening methods were primarily implemented by tread block design features; examples include the insertion of voids and sipes, tapered or chamfered block edges, and reinforced tread block buttressing.

It is also known to provide a tire tread having sectors formed with a first material having a first modulus of elasticity and other sectors formed with a second material having a second modulus of elasticity. What is needed, however, is a method of significantly and effectively increasing the directional stiffness characteristics of portions of a tire tread.

### SUMMARY OF THE INVENTION

A pneumatic tire in accordance with the present invention includes a tread base comprised of a first material, a tread cap comprised of a second material, and a plurality of plugs comprised of a third and/or more materials. The tread cap is disposed radially outward of the tread base and in operational contact with a ground surface. The plurality of plugs are disposed at least partially within at least one of the tread base and the tread cap. The plurality of plugs yield a tread stiffness in a first direction greater than the stiffness in at least one other direction.

According to another aspect of the present invention, the first direction is radial and the other direction is one of circumferential and lateral.

According to another aspect of the present invention, the plurality of plugs form at least one circumferential ring disposed in a shoulder portion of the tread. Additionally, the plurality of plugs may be disposed in another area(s) of the tread. For example, the plurality of plugs may form several rings in each circumferential area of the tread, such as each tread block.

According to still another aspect of the present invention, the third material has a substantially higher modulus of elasticity than the second material.

According to yet another aspect of the present invention, the third material has a substantially higher modulus of elasticity than the first material.

According to yet another aspect of the present invention, the third material has a substantially lower hysteresis than the second material.

According to yet another aspect of the present invention, the third material has a substantially lower hysteresis than the first material.

According to still another aspect of the present invention, the third material is a metal, such as steel, stainless steel, brass, bronze, galvanized steel, copper, or any other suitable metal.

According to yet another aspect of the present invention, the third material is nylon.

According to still another aspect of the present invention, the third material is a polymer, such as, for example, the thermoplastic polymers: polyamides, poly ether-ether ketones, polyimides, polybutylene terephalates, polyethylene terephalates, poly(phenylene sulfide), and liquid crystal polymers. Additionally, the third material may be a thermoplastic polymer with added inorganic fillers such as, for example, carbon fiber, glass fiber, glass flake, talc, mica, silica, glass beads, and calcium carbonate. Furthermore, the third material may be thermosetting polymer and/or a thermosetting composite such as, for example, syndiotactic polybutadiene polymer, epoxy polymer, crosslinked urethane polymer, and unsaturated polyester (e.g., bulk molding compound). Also, the third material may be a thermosetting polymer composite with added inorganic fillers such as, for example, carbon fiber, glass fiber, glass flake, talc, mica, silica, glass beads, and calcium carbonate.

According to yet another aspect of the present invention, the third material is a syndiotactic polybutadiene polymer.

According to still another aspect of the present invention, the plurality of plugs are temporarily secured to a green tire such that the tread cap, the tread base, and the plurality of plugs are cured simultaneously.

According to yet another aspect of the present invention, the plurality of plugs are finally secured to the tread cap and tread base by the simultaneous curing.

According to still another aspect of the present invention, the plurality of plugs are inserted into the tread cap subsequent to the tread cap and tread base being cured.

According to yet another aspect of the present invention, an adhesive further secures the plurality of plugs to the tread cap.

According to still another aspect of the present invention, the adhesive further secures the plurality of plugs to the tread base.

According to yet another aspect of the present invention, the third material has a dynamic storage modulus of between 1 MPa and 200,000 MPa.

According to still another aspect of the present invention, the third material has a dynamic storage modulus of between 1 MPa and 20,000 MPa.

According to yet another aspect of the present invention, the third material has a dynamic storage modulus of between 1 MPa and 1,000 MPa.

According to still another aspect of the present invention, the third material has a dynamic storage modulus of between 1 MPa and 8 MPa.

According to yet another aspect of the present invention, the third material has a dynamic storage modulus of between 1.5 MPa and 5 MPa.

According to still another aspect of the present invention, the second material has a dynamic storage modulus of between 0.25 MPa and 3 MPa.

According to yet another aspect of the present invention, the second material has a dynamic storage modulus of between 0.5 MPa and 2.5 MPa.

According to still another aspect of the present invention, the difference between the dynamic storage moduli of the third material and the second material is greater than 0.5 MPa.

According to yet another aspect of the present invention, the difference between the dynamic storage moduli of the third material and the second material is greater than 1 MPa.

Another tire in accordance with the present invention includes a carcass and a tread having a tread base formed of a first material, a tread cap formed of a second material having a substantially different modulus than the first material, and a plurality of plugs formed of a third material having a substantially different modulus than the first material. The plugs extend from the tread base through the tread cap to a ground contacting surface of the tread.

### BRIEF DESCRIPTION OF THE DRAWINGS

The invention may take physical form in certain parts and arrangement of parts, example embodiments of which will be described in detail in this specification and illustrated in the accompanying drawings which form a part hereof and wherein:

FIG. 1 is a front elevation of an example tire constructed in accordance with the present invention.

FIG. 2 is a partial cross-section of the example tire of FIG. 1.

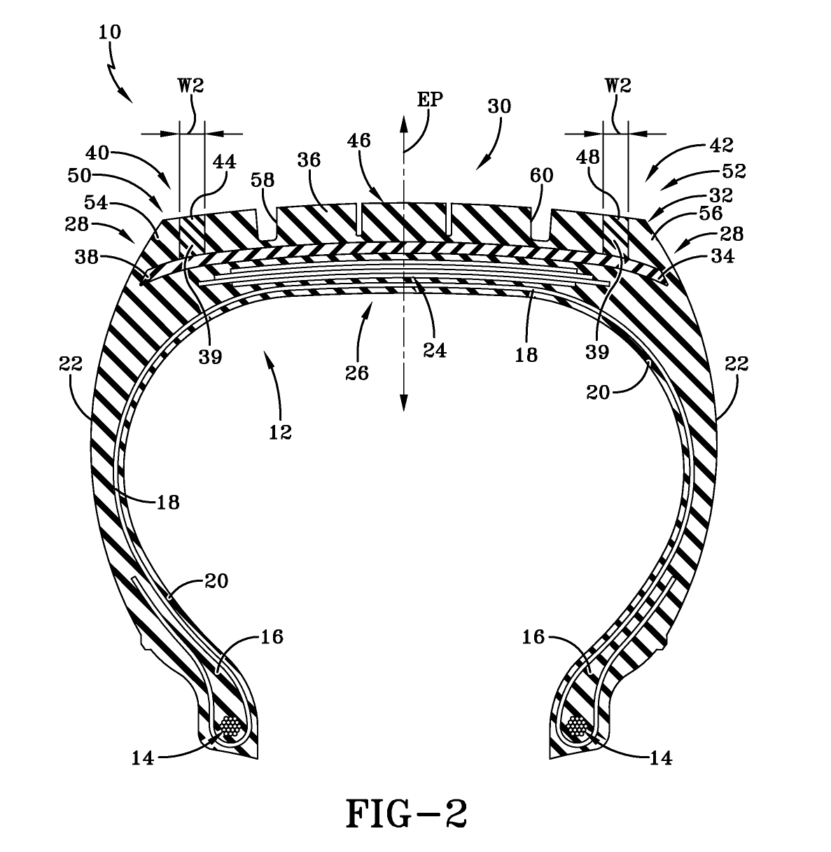

FIG. 3 is a schematic illustration of the various moduli for an example tread in accordance with the present invention.

### DEFINITIONS

“Apex” means an elastomeric filler located radially above the bead core and between the plies and the turnup ply.

“Annular” means formed like a ring.

“Aspect ratio” means the ratio of its section height to its section width.

“Axial” and “axially” are used herein to refer to lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt structure” means at least two annular layers or plies of parallel cords, woven or unwoven, underlying the tread, unanchored to the bead, and having cords inclined respect to the equatorial plane of the tire. The belt structure may also include plies of parallel cords inclined at relatively low angles, acting as restricting layers.

“Bias tire” (cross ply) means a tire in which the reinforcing cords in the carcass ply extend diagonally across the tire from bead to bead at about a 25°-65° angle with respect to equatorial plane of the tire. If multiple plies are present, the ply cords run at opposite angles in alternating layers.

“Breakers” means at least two annular layers or plies of parallel reinforcement cords having the same angle with reference to the equatorial plane of the tire as the parallel reinforcing cords in carcass plies. Breakers are usually associated with bias tires.

“Cable” means a cord formed by twisting together two or more plied yarns.

“Carcass” means the tire structure apart from the belt structure, tread, undertread, and sidewall rubber over the plies, but including the beads.

“Casing” means the carcass, belt structure, beads, sidewalls and all other components of the tire excepting the tread and undertread, i.e., the whole tire.

“Chipper” refers to a narrow band of fabric or steel cords located in the bead area whose function is to reinforce the bead area and stabilize the radially inwardmost part of the sidewall.

“Circumferential” means lines or directions extending along the perimeter of the surface of the annular tire parallel to the Equatorial Plane (EP) and perpendicular to the axial direction; it can also refer to the direction of the sets of adjacent circular curves whose radii define the axial curvature of the tread, as viewed in cross section.

“Cord” means one of the reinforcement strands of which the reinforcement structures of the tire are comprised.

“Cord angle” means the acute angle, left or right in a plan view of the tire, formed by a cord with respect to the equatorial plane. The “cord angle” is measured in a cured but uninflated tire.

“Cord Density” means weight per unit length of cord.

“Crown” means that portion of the tire within the width limits of the tire tread.

“Denier” means the weight in grams per 9000 meters (unit for expressing linear density). “Dtex” means the weight in grams per 10,000 meters.

“Elastomer” means a resilient material capable of recovering size and shape after deformation.

“Equatorial plane (EP)” means the plane perpendicular to the tire's axis of rotation and passing through the center of its tread; or the plane containing the circumferential centerline of the tread.

“Fabric” means a network of essentially unidirectionally extending cords, which may be twisted, and which in turn are composed of a plurality of a multiplicity of filaments (which may also be twisted) of a high modulus material.

“Fiber” is a unit of matter, either natural or man-made that forms the basic element of filaments. Characterized by having a length at least 100 times its diameter or width.

“Filament count” means the number of filaments that make up a yarn. Example: 1000 denier polyester has approximately 190 filaments.

“Flipper” refers to a reinforcing fabric around the bead wire for strength and to tie the bead wire in the tire body.

“Gauge” refers generally to a measurement, and specifically to a thickness measurement.

“High Tensile Steel (HT)” means a carbon steel with a tensile strength of at least 3400 MPa @ 0.20 mm filament diameter.

“Inner” means toward the inside of the tire and “outer” means toward its exterior.

“Innerliner” means the layer or layers of elastomer or other material that form the inside surface of a tubeless tire and that contain the inflating fluid within the tire.

“LASE” is load at specified elongation.

“Lateral” means an axial direction.

“Lay length” means the distance at which a twisted filament or strand travels to make a 360 degree rotation about another filament or strand.

“Load Range” means load and inflation limits for a given tire used in a specific type of service as defined by tables in The Tire and Rim Association, Inc.

“Mega Tensile Steel (MT)” means a carbon steel with a tensile strength of at least 4500 MPa @ 0.20 mm filament diameter.

“Normal Load” means the specific design inflation pressure and load assigned by the appropriate standards organization for the service condition for the tire.

“Normal Tensile Steel (NT)” means a carbon steel with a tensile strength of at least 2800 MPa @ 0.20 mm filament diameter.

“Ply” means a cord-reinforced layer of rubber-coated radially deployed or otherwise parallel cords.

“Radial” and “radially” are used to mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which at least one ply has cords which extend from bead to bead are laid at cord angles between 65° and 90° with respect to the equatorial plane of the tire.

“Rivet” means an open space between cords in a layer.

“Section Height” means the radial distance from the nominal rim diameter to the outer diameter of the tire at its equatorial plane.

“Section Width” means the maximum linear distance parallel to the axis of the tire and between the exterior of its sidewalls when and after it has been inflated at normal pressure for 24 hours, but unloaded, excluding elevations of the sidewalls due to labeling, decoration or protective bands.

“Sidewall” means that portion of a tire between the tread and the bead.

“Stiffness ratio” means the value of a control belt structure stiffness divided by the value of another belt structure stiffness when the values are determined by a fixed three point bending test having both ends of the cord supported and flexed by a load centered between the fixed ends.

“Super Tensile Steel (ST)” means a carbon steel with a tensile strength of at least 3650 MPa @ 0.20 mm filament diameter.

“Tenacity” is stress expressed as force per unit linear density of the unstrained specimen (gm/tex or gm/denier). Used in textiles.

“Tensile” is stress expressed in forces/cross-sectional area. Strength in psi=12,800 times specific gravity times tenacity in grams per denier.

“Toe guard” refers to the circumferentially deployed elastomeric rim-contacting portion of the tire axially inward of each bead.

“Tread” means a molded rubber component which, when bonded to a tire casing, includes that portion of the tire that comes into contact with the road when the tire is normally inflated and under normal load.

“Tread width” means the arc length of the tread surface in a plane including the axis of rotation of the tire.

“Turnup end” means the portion of a carcass ply that turns upward (i.e., radially outward) from the beads about which the ply is wrapped.

“Ultra Tensile Steel (UT)” means a carbon steel with a tensile strength of at least 4000 MPa @ 0.20 mm filament diameter.

“Yarn” is a generic term for a continuous strand of textile fibers or filaments. Yarn occurs in the following forms: 1) a number of fibers twisted together; 2) a number of filaments laid together without twist; 3) a number of filaments laid together with a degree of twist; 4) a single filament with or without twist (monofilament); 5) a narrow strip of material with or without twist.

### DETAILED DESCRIPTION OF THE INVENTION

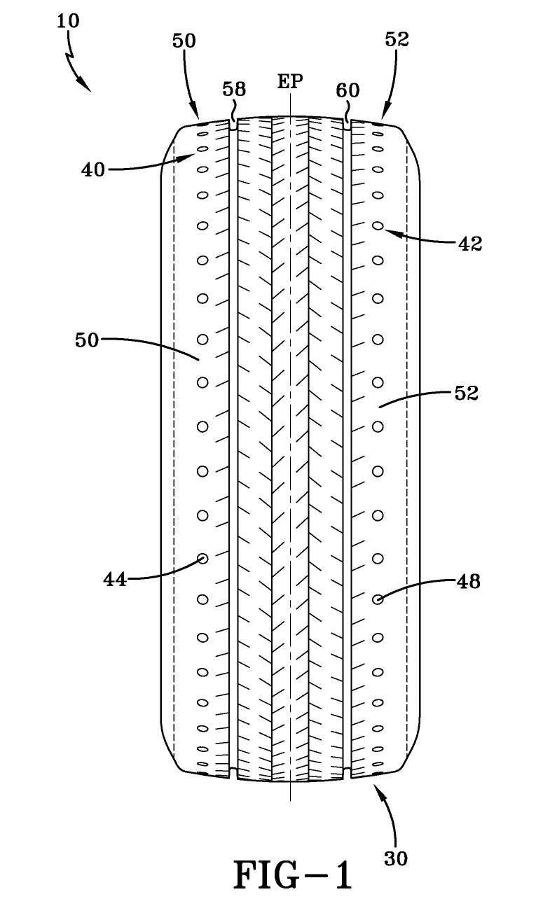

Referring now to the drawings wherein the showings are for purposes of illustrating embodiments of the present invention only and not for purposes of limiting the same, and wherein like reference numerals are understood to refer to like components, FIGS. 1 & 2 show a pneumatic tire 10 having an example tread 30 in accordance with the present invention. The example tread 30 may be positioned onto an example carcass 12. The example carcass 12 may include a pair of first and second annular beads 14 and a pair of apexes 16 positioned radially above the first and second annular beads 14. The example carcass 12 may include one or more plies 18 that may extend around the beads 14. The example carcass 12 may further define a crown region 26 and a pair of sidewalls 28. The carcass 12 may include other components, such as an inner liner 20, sidewall rubber portions 22, a belt package 24, and an overlay (not shown).

The example tire tread 30 is shown in its cured and finished state in FIGS. 1 & 2. The tread 30 may have a tread cap 32 formed of a first material 36 and a tread base 34 formed of a second material 38. The first material 36 may have a modulus substantially different than the second material 38. The second material 38 may have a substantially higher modulus than the first material 36. Alternatively, the first material 36 and the second material 38 may be the same. The tread 30 may have a first set 40 of plugs 44, or z-plugs, of a third material 39 that extend radially from the tread base 34 through the tread cap 32 to an outer ground contacting surface 46 of the tread. The tread 30 may also have a second set 42 of plugs 48, or z-plugs, of the third material 39 (or alternatively a fourth different material) that extend radially from the tread base 34 through the tread cap 32 to the outer ground contacting surface 46 of the tread. The first set 40 of plugs 44 may be positioned in a first shoulder 50 of the tread 30 and the second set 42 of plugs 48 may be positioned in a second shoulder 52 of the tread.

The stiffness of the shoulders 50, 52 may be adjusted so as to affect several tire performance characteristics. While the plugs 44, 48 are shown positioned within tread elements 54, 56, the plugs may also be positioned at other parts of the tread 30, such as grooves 58, 60 in FIGS. 1 & 2. While the plugs 44, 48 shown define a specific number, the use of any number and/or dimensions of plugs may be used depending upon tire size and desired performance characteristics. The plugs 44, 48 may extend completely between the tread base 34 and the tread surface 46, or only partially.

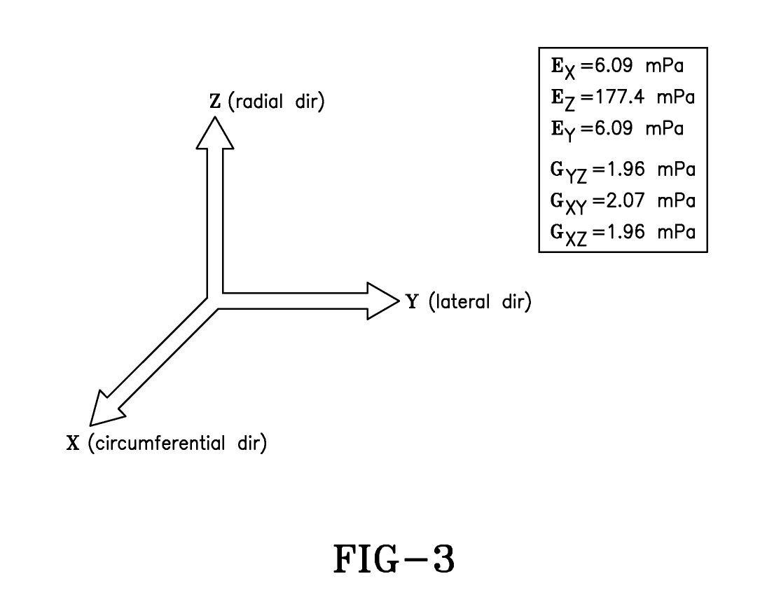

With the plugs 44, 48 of the present invention, the tread 30 may exhibit directionally dependent stiffnesses. As an example (FIG. 3), the plugs 44, 48 may have a high stiffness in the vertical or Z direction resulting in greatly reduced compressive strains of the tread 30 in the Z direction. Depending on the relative volume loading of the pins (geometry and quantity of pins per unit volume of tread rubber), the tread 30, furthermore, may have a relatively reduced stiffness in the circumferential or X direction and the lateral or Y direction (vs that of the vertical or Z direction). This high stiffness in the Z direction of the plugs 44, 48 or combination of effects of the plugs and the other structures of the tire 10 may thus result in significantly reduced rolling resistance (RR) of the tire 10 without significantly diminishing other tire performance criteria. Pre-cured plugs 44, 48 may be temporarily secured to a green tire and cured simultaneously with the other structures of the tire 10. Alternatively, cured plugs 44, 48 may be secured to the tread cap 32 and/or tread base 34 subsequent to the curing of the other structures of the tire 10.

Cyclic tread compressive strains may be significantly reduced by using a material/configuration with increased modulus in the thickness or Z direction. This results in reduced RR, attributable to the Z directed load-bearing actions without significantly increasing the stresses in the X and Y directions. Managing the simultaneous cyclic stress and strain cycles for reduced RR from all of these mechanisms may thus require a relatively high stiffness in the Z direction with a relatively low stiffness in the X and/or Y directions.

One method of obtaining these desired directional stiffness characteristics is to use a combination of materials within the tread. The Z directed stiffening may be achieved with relatively high modulus material 39 embedded within a relatively low modulus rubber matrix 36 with a unique geometry. For example, in accordance with the present invention, plugs 44, 48, of high modulus material 39 with appropriate spacing throughout the tread 30 and extending substantially in the Z direction may resist Z directed stresses, while the surrounding tread cap material 36 interconnecting the plugs 44, 48 may provide relatively low stiffness properties in the X and Y directions.

Various configurations of the tread cap/tread base/plug combination of materials 36, 38, 39 may be implemented. Also, various orientations of the relatively high modulus plugs 44, 48 may be implemented. For example, if oriented at 45 degrees relative to the X direction (not shown), increased shear stiffness of the tread 30 may result. This may be desirable for improving cornering, braking/driving traction, etc. Calculations indicate that RR may be reduced by over 30% by Z directed plugs (FIGS. 1 & 2). Furthermore, placement and number of the plugs may be at any location of the tread, both circumferentially and laterally, with any design and dimensions. Additionally, example materials 39 for the plugs 44, 48 may be a suitable metal, polymer, and/or plastic with a melting point above 150 degrees Celsius.

Further, the tread cap 36 and tread base 38 may be integrally formed of the same material as a single structure (not shown), or the tread base may be omitted. The tread cap structure may then be located directly and radially adjacent the belt package 24 or overlay.

Rubber-like materials 39 for the plugs 44, 48 may be tested by a Rubber Process Analyzer, or “RPA,” such as RPA 2000™ instrument by Alpha Technologies, formerly Flexsys Company and formerly Monsanto Company. References to an RPA 2000 instrument may be found in the following publications: H. A. Palowski, et al, Rubber World, June 1992 & January 1997, as well as Rubber & Plastics News, Apr. 26, 1993 & May 10, 1993. The RPA test results may be reported from data obtained at 100 degrees C. in a dynamic shear mode at a frequency of 11 hertz and at 10% dynamic strain values.

The X-Y cross-section of example plugs 44, 48 may be a circle, square, triangle, pentagon, hexagon, heptagon, octagon, nonagon, pentagon, or other suitable shape. The X-Y cross-section of example plugs 44, 48 may also vary as the plugs extend in the Z direction (e.g., a plug which narrows as it extends radially away from the wheel may be more securely attached to the tread than a plug that does not vary). An example cylindrical plug in accordance with the present invention may have a diameter W2 between 0.5 mm and 60 mm and a radial or Z length between 15 mm and 80 mm depending upon the tread size and configuration. Another example cylindrical plug may have a diameter of 2 mm and be spaced apart between 1 mm and 2 mm.

The harder plug material 39 may have a dynamic storage modulus between 1 MPa and 200,000 MPa, or between 1 MPa and 8 MPa, or between 1.5 MPa and 5 MPa. The softer tread cap material 32 may have a dynamic storage modulus between 0.25 MPa and 3 MPa, or between 0.5 MPa and 2.5 MPa. Further, the difference between the dynamic storage moduli of the plug material 39 and the tread cap material 32 may be greater than 0.5 MPa, or greater than 1 MPa.

“Tan Delta” values determined at 10% strain may be a ratio of dynamic loss modulus to dynamic storage modulus and may be considered a measure of hysteresis wherein a lower hysteresis of a tread material 36, 38, and/or 39 may be desirable for lesser RR. A decrease in the Tan Delta value may correspond to a desirable decrease in hysteresis of the plug material 39. Thus, materials 39 for the plugs 44, 48 may have a low Tan Delta and low hysteresis.

One example material 39 for the plugs 44, 48 may be a syndiotactic polybutadiene polymer (“SPBD”). SPBD differs from other polybutadienes (e.g. differs from cis 1,4-polybutadiene rubber) in that SPBD has a vinyl 1,2-content of at least 80 percent which may vary from about 80 percent to at least about 96 percent. SPBD may be flexible, but is not generally considered an elastomer. Moreover, SPBD has little or no building tack for adhering to uncured conjugated diene-based rubber compositions, unless SPBD is first blended with one or more elastomers which ordinarily required an addition of a compatibilizer and perhaps a tackifying resin to do so.

Therefore, unwanted movement of plugs 44, 48 of SPBD may occur against an uncured rubber component during a tire building and forming process, unless the plugs 44, 48 are at least partially pre-cured against a green rubber component prior to curing of the green tire. Plugs 44, 48 of SPBD may provide the Z direction stiffness discussed above. Thus, it may be desirable that no elastomer, compatabilizing agent, or tackifying resin be physically blended with the SPBD, unless used in very small amounts thereby not compromising the melting point of the SPBD.

SPBD may be a relatively rigid (limited flexibility) crystalline polymer with poor solubility in elastomers without the addition of a compatibilizer. For the present invention, as indicated above, SPBD may form the plugs 44, 48, thereby providing some flexibility and not being blended with materials 36, 38 of the tread cap 32 and tread base 34, nor a compatibilizer. The melting point (MP) of SPBD may vary with the content of 1,2-microstructure. For example, MP values may range from about 120° C. at about an 80 percent vinyl 1,2-content up to about 200° C. to 210° C. for about a 96 percent vinyl 1,2-content for its microstructure.

For the present invention, SPBD may have a melting point (MP) temperature of at least 150° C., or from about 160° C. to about 220° C., so that the plugs 44, 48 retain a significant degree of dimensional stability and thereby add stiffness and dimensional stability/support to the tread 30 at a relatively high temperature as the tread generates heat when being dynamically worked. Higher MP's may be preferred for the plugs 44, 48. Further, the SPBD may contain a dispersion of one or more reinforcing fillers. In order to make the SPBD plugs 44, 48 integral with the tread cap 32 and/or tread base 34, the plugs may be co-cured with the sulfur curable tread cap and tread base. For such co-curing of the SPBD plugs 44, 48, the interface between the plugs and the tread cap 32 and/or tread base 34 may rely upon: (A) one or more sulfur curatives contained within the SPBD, (B) one or more sulfur curatives contained within tread cap and/or tread base, or (C) one or more sulfur curatives contained in each of the SPBD and tread cap 32 and/or tread base 34.

SPBD may be made integral with the tread cap 32 and/or tread base 34 by co-curing the SPBD and tread cap and/or tread base together at an elevated temperature in which the SPBD and tread cap and/or tread base may be integrated with each other at the interface between the SPBD and tread cap and/or tread base. Plugs 44, 48 of SPBD may provide dimensional stability (e.g., a degree of rigidity) for the tread 30 by the integrated, co-cured plug/tread cap/tread base interface.

Alternatively, pre-cured plugs 44, 48 of SPBD or other stiff material may be installed in appropriately sized holes in the tread 30 subsequent to the curing of the other parts of the tire 10. An adhesive layer may be applied at the interface between the SPBD and tread cap and/or tread base for securing the plugs 44, 48 in place.

Further, it may not be desirable to blend the SPBD with other elastomers because such blending may dilute or degrade the dimensional stability of the SPBD plugs 44, 48. The terms “rubber” and “elastomer” may be used interchangeably unless otherwise indicated. The terms “rubber composition” and “compound” may be used interchangeably unless otherwise indicated. The term “melting point, or “MP” as used herein may mean the melting temperature of the SPBD measured by conventional differential scanning calorimetry using a 10° C./minute temperature rise. The term “softening point” as used herein may mean the transition temperature from a hard/stiff material to a soft/rubbery material.

As stated above, a tread 30 with plugs 44, 48 in accordance with the present invention produces excellent directional stiffness characteristics in a pneumatic tire 10. The plugs 44, 48 thus enhance the performance of the pneumatic tire 10, even though the complexities of the structure and behavior of the pneumatic tire are such that no complete and satisfactory theory has been propounded. Temple, Mechanics of Pneumatic Tires (2005). While the fundamentals of classical composite theory are easily seen in pneumatic tire mechanics, the additional complexity introduced by the many structural components of pneumatic tires readily complicates the problem of predicting tire performance. Mayni, Composite Effects on Tire Mechanics (2005). Additionally, because of the non-linear time, frequency, and temperature behaviors of polymers and rubber, analytical design of pneumatic tires is one of the most challenging and underappreciated engineering challenges in today's industry. Mayni.

A pneumatic tire has certain essential structural elements. United States Department of Transportation, Mechanics of Pneumatic Tires, pages 207-208 (1981). An important structural element is the belt structure, typically made up of many cords of fine hard drawn steel or other metal embedded in, and bonded to, a matrix of low modulus polymeric material, usually natural or synthetic rubber. Id. at 207 through 208.

The cords are typically disposed as a single or double layer. Id. at 208. Tire manufacturers throughout the industry cannot agree or predict the effect of different twists of cords of the belt structure on noise characteristics, handling, durability, comfort, etc. in pneumatic tires, Mechanics of Pneumatic Tires, pages 80 through 85.

These complexities are demonstrated by the below table of the interrelationships between tire performance and tire components.

| | | CARCASS | | | | | |
|---|---|---|---|---|---|---|---|
| | LINER | PLY | APEX | BELT | OV'LY | TREAD | MOLD |
| TREADWEAR | | | | X | | X | X |
| NOISE | | X | X | X | X | X | X |
| HANDLING | | X | X | X | X | X | X |
| TRACTION | | | | | | X | X |
| DURABILITY | X | X | X | X | X | X | X |
| ROLL RESIST | X | | X | X | | X | X |
| RIDE | X | X | X | | | X | |
| COMFORT | | | | | | | |
| HIGH SPEED | | X | X | X | X | X | X |
| AIR | X | | | | | | |
| RETENTION | | | | | | | |
| MASS | X | X | X | X | X | X | X |

As seen in the table, the tread characteristics affect the other components of a pneumatic tire (i.e., the tread affects belt, etc.), leading to a number of components interrelating and interacting in such a way as to affect a group of functional properties (noise, handling, traction, durability, rolling resistance, comfort, high speed, and mass), resulting in a completely unpredictable and complex composite. Thus, changing even one component can lead to directly improving or degrading as many as the above ten functional characteristics, as well as altering the interaction between that one component and as many as six other structural components. Each of those six interactions may thereby indirectly improve or degrade those ten functional characteristics. Whether each of these functional characteristics is improved, degraded, or unaffected, and by what amount, certainly would have been unpredictable without the experimentation and testing conducted by the inventors.

Thus, for example, when the tread of a pneumatic tire is modified with the intent to improve one functional property of the pneumatic tire, any number of other functional properties may be unacceptably degraded. Furthermore, the interaction between the tread and the belt may also unacceptably affect the functional properties of the pneumatic tire. A modification of the tread may not even improve that one functional property because of these complex interrelationships.

Thus, as stated above, the complexity of the interrelationships of the multiple components makes the actual result of modification of a tread 30, in accordance with the present invention, impossible to predict or foresee from the infinite possible results. Only through extensive experimentation have the plugs 44, 48 and tread 30 of the present invention been revealed as an excellent, unexpected, and unpredictable option for a pneumatic tire.

The previous descriptive language is of the best presently contemplated mode or modes of carrying out the present invention. This description is made for the purpose of illustrating an example of general principles of the present invention and should not be interpreted as limiting the present invention. The scope of the invention is best determined by reference to the appended claims. The reference numerals as depicted in the schematic drawings are the same as those referred to in the specification. For purposes of this application, the various examples illustrated in the figures each use a same reference numeral for similar components. The examples structures may employ similar components with variations in location or quantity thereby giving rise to alternative constructions in accordance with the present invention.

What is claimed:

1. A pneumatic tire comprising:
a tread base comprised of a first material;
a tread cap comprised of a second material, the tread cap being disposed radially outward of the tread base and in operational contact with a ground surface; and
a plurality of plugs comprised of a third material, the plurality of plugs being disposed at least partially within at least one of the tread base and the tread cap, the plurality of plugs yielding a tread stiffness in a first direction greater than stiffness in at least one other direction.

2. The pneumatic tire as set forth in claim 1 wherein the first direction is radial and the one other direction is one of circumferential and lateral.

3. The pneumatic tire as set forth in claim 2 wherein the plurality of plugs form at least one circumferential ring disposed in a shoulder portion of the tread.

4. The pneumatic tire as set forth in claim 2 wherein the third material has a substantially higher modulus of elasticity than the second material.

5. The pneumatic tire as set forth in claim 4 wherein the third material has a substantially higher modulus of elasticity than the first material.

6. The pneumatic tire as set forth in claim 1 wherein the third material has a substantially lower hysteresis than the second material.

7. The pneumatic tire as set forth in claim 6 wherein the third material has a substantially lower hysteresis than the first material.

8. The pneumatic tire as set forth in claim 1 wherein the third material is a metal.

9. The pneumatic tire as set forth in claim 1 wherein the third material is nylon.

10. The pneumatic tire as set forth in claim 1 wherein the third material is a polymer.

11. The pneumatic tire as set forth in claim 1 wherein the third material is a syndiotactic polybutadiene polymer.

12. The pneumatic tire as set forth in claim 1 wherein the plurality of plugs is temporarily secured to a green tire such that the tread cap, the tread base, and the plurality of plugs are cured simultaneously.

13. The pneumatic tire as set forth in claim 12 wherein the plurality of plugs is finally secured to the tread cap and tread base by the simultaneous curing.

14. The pneumatic tire as set forth in claim 1 wherein the plurality of plugs are inserted into the tread cap subsequent to the tread cap and tread base being cured.

15. The pneumatic tire as set forth in claim 14 wherein an adhesive further secures the plurality of plugs to the tread cap.

16. The pneumatic tire as set forth in claim 15 wherein the adhesive further secures the plurality of plugs to the tread base.

17. The pneumatic tire as set forth in claim 1 wherein the third material has a dynamic storage modulus of between 1 MPa and 200,000 MPa.

18. The pneumatic tire as set forth in claim 1 wherein the third material has a dynamic storage modulus of between 1.5 MPa and 8 MPa.

19. The pneumatic tire as set forth in claim 1 wherein the second material has a dynamic storage modulus of between 0.25 MPa and 3 MPa.

20. The pneumatic tire as set forth in claim 1 wherein the second material has a dynamic storage modulus of between 0.5 MPa and 2.5 MPa.

21. The pneumatic tire as set forth in claim 1 wherein the difference between the dynamic storage moduli of the third material and the second material is greater than 0.5 MPa.

22. The pneumatic tire as set forth in claim 1 wherein the difference between the dynamic storage moduli of the third material and the second material is greater than 1 MPa.

23. A tire comprising:
a carcass; and
a tread having a tread base formed of a first material, a tread cap formed of a second material having a substantially different modulus than the first material; and a plurality of plugs formed of a third material having a substantially different modulus than the first material, the plugs extending from the tread base through the tread cap to a ground contacting surface of the tread.

24. The pneumatic tire as set forth in claim 1 wherein the plurality of plugs are primarily oriented in a first angular direction and a second angular direction.

25. The pneumatic tire as set forth in claim 24 wherein the first angular direction is directly radial and the second angular direction is between 20 degrees and 70 degrees relative to the first angular direction.

26. The pneumatic tire as set forth in claim 1 wherein the first material is the same as the second material.
